(19) United States
(12) Patent Application Publication
(10) Pub. No.: US 2013/0140848 A1
(43) Pub. Date: Jun. 6, 2013

(54) Pop-Up Camper Expansible Through Rotation

(71) Applicant: Stephen W. Shanley, Buffalo, NY (US)

(72) Inventor: Stephen W. Shanley, Buffalo, NY (US)

(21) Appl. No.: 13/312,512

(22) Filed: Dec. 6, 2011

(51) Int. Cl. B60P 3/39

(52) U.S. Cl. 296/172

(57) ABSTRACT

A pop-up camper expansible through rotation is provided and it has a camper box having a pivot shaft and a trailer frame having a pivot shaft housing. The pivot shaft is disposed in the pivot shaft housing. The trailer frame is disposed above the trailer wheels to allow the camper box to pivot and rotate relative to the frame between transport and rotated positions. The rotated configuration allows opposed dinette and bed units to be substantially deployable outside of the camper box, revealing a generally square-shaped central living area. Room is created for a shower/toilet unit, a 7-foot wide galley, and doors wide enough to accommodate campers in wheelchairs. The dinette may be converted into a bunk bed and the squared-off living area creates a more livable, multi-purpose internal space. Timesaving options are provided for cranking out deployed units and raising a roof. Environmental friendly green materials are recommended.

### BACKGROUND

Recreational camping is a well-established pastime throughout the world, but recent economic conditions and increased concerns over global and environmental issues have reduced consumers' willingness and ability to haul camper trailers over 1,500 lbs. (including pop-ups, 5th wheels, truck cab inserts, etc.), as these all require use of gas-guzzling and expensive trucks, SUVs, and mini-vans. In addition, large trailers are difficult to store and maneuver on the road and they take up considerable room in campgrounds and other off-road sites. More modest family sedans generally can haul only up to 8 (eight) foot campers, with these units being quite limited in utility due to their lack of interior space and amenities. Camping enthusiasts, however, have grown used to the several amenities provided by the larger and heavier campers, including running water, gas stoves, furnaces, storage areas, and showers/bathrooms built into the camper. Although there have been minor improvements over the years in material and technology, the basic box-like pop-up configuration has changed little during the last 50 years. Pop-ups generally have double or queen size beds that slide out from the short front and rear ends of the campers, but the camping enthusiast is often forced to climb over furniture, for example dinette benches and other fold-out beds in order to reach the double or queen sized beds. Camping enthusiasts need to pull out the second bed just to access the rest of the camper, whether or not they need the bed. In addition, these bed extensions take up over twenty-two feet when in the fully extended mode at the campsite, reducing the range of sites that can accommodate these pop-ups. Although so-called slide-outs were added as a dining feature in the 1980's, these units typically are cantilevered less than halfway out from the sides of the basic box. This was necessary in order to maintain the balance of the overall camper. These slide-outs are also only available in the bigger and more expensive models, and not for the sedan-driving or small car public. With or without slide-outs, all existing camper configurations provide for a narrow central aisle for accessing all the features of the camper. This causes undesirable cramping in the camper and as a result people inside the camper are forced to move about the interior of the camper by walking in a cumbersome stilted manner. Finally, traditional pop-up campers are difficult to store, especially in urban areas with limited room. The tongue, frame and box itself can take up an 18-24 foot space depending on the model.

U.S. Pat. No. 7,267,392 (hereinafter “the '392 patent”) to Rounds discloses rotation of the camper box. However, the '329 patent requires a towing truck for moving the camper. This undesirably increases the cost, weight and complexity of the camper. The camper disclosed in the '329 patent appears to focus on preserving the ability of the trailer bed to carry ATVs, boats, etc. while also carrying a small camper. In addition, the stated reason for rotation of the camper in the '329 patent is so that it is easier access to the side door of the camper (by swinging the camper away from any vehicle loaded onto the back of the trailer). Also, the schematic (Fig. A) in the '329 patent shows the camper resting on lift jacks and braces some inches off the trailer bed. This is believed to produce excessive wind drag, potential instability while hauling and results in an unnecessarily cumbersome deployment.

The cost of wood and ecological damage caused by deforestation have moved all manufactures to use variations of particle or pressboard with either simulated or thin wood veneers for interior furnishings and surfaces. Formaldehyde and other bonding agents in the glues and resins that form the boards have unknown health impact. There is a growing interest in the use of ‘green,’ renewable, cheaper, recyclable, and healthier building materials. Bamboo is a rapidly growing, easily renewed material with surprisingly strong tensile properties.

Finally, current camper construction has traditionally used white or aluminized exterior cladding, whether vinyl or some metalicized material. Such campers do not blend into their environments and often lack aesthetic appeal. Thus, there is a need for an improved pop-up camper.

### SUMMARY

A pop-up camper expansible through rotation is provided that comprises a camper box that is supported on a trailer. The trailer has a frame with a first, a second, a third and a fourth corner and the frame is supported on a pair of wheels. The frame further includes opposed first and third frame members and opposed second and fourth frame members that together form a substantially rectangular shape. A cross support frame having a pivot shaft housing is joined to the first, second, third and fourth corners such that the pivot shaft housing is substantially centrally positioned in the frame.

The camper box has a base and a camper box rotation plate is joined with the base. The camper box rotation plate has a pivot shaft that extends from the camper rotation plate. The pivot shaft is positioned in the pivot shaft housing such that the camper box is rotatable relative to the frame between a transport position and a rotated position. In one of the preferred embodiments the pop-up camper expansible through rotation is rotated on a rotation track. In another preferred embodiment the pop-up camper expansible through rotation includes a camper box rotation plate that is positioned and supported on a frame rotation plate. In one of the preferred embodiments the camper box and frame rotation plates are made of a low friction material to facilitate rotation of the camper box relative to the frame.

The camper box rotation plate has a diameter that is approximately the inner distance between the opposed first and third frame members. The pivot shaft housing has a pivot shaft housing opening and the pivot shaft has a pivot shaft opening, and the pivot shaft housing opening and the pivot shaft opening are aligned when the pivot shaft is received in the pivot shaft housing. The pivot shaft opening is for accommodating wiring, hoses and tubing.

The camper box has a dinette side wall disposed opposite a bed side wall, and a galley side wall disposed opposite a door side wall. The dinette and bed side walls have a length that is greater than a length of the galley and door side walls and are therefore longer as compared to the shorter galley and door side walls. When the camper box is rotated to the rotated position a dinette unit is deployed from the dinette side wall and is reconfigurable into a sleeper unit, and a bed frame and box assembly is deployed from the bed side wall. This advantageously provides for an improved configuration of the available space in the camper box thus making it significantly user-friendlier as compared to existing camper boxes.

The frame has a tongue and in one of the preferred embodiments the tongue is retractable to an out of the way position. In another preferred embodiment a hinged tongue is provided that allows the tongue to be stored in an out of the way position.

The camper may manually pull on handles to deploy the dinette unit and bed frame and box assembly from the camper box. In another preferred embodiment the dinette unit and bed frame and box assembly are deployed via a rack and gear assembly. In another preferred embodiment the dinette unit and bed frame and box assembly are deployed with a hand crank deployment assembly that also raises a roof of the camper box on lifter posts.

### BRIEF DESCRIPTION OF THE DRAWING FIGURES

FIG. 1 is a top plan view of a pop-up camper expansible through rotation wherein a camper box is in a transport position relative to a trailer.

FIG. 2 is a front elevation view of the pop-up camper expansible through rotation of FIG. 1.

FIG. 3 is a top plan view of the pop-up camper expansible through rotation after the camper box has been rotated counterclockwise relative to the trailer.

FIG. 4 is a front elevational view of the pop-up camper expansible through rotation wherein the camper box is in a rotated position.

FIG. 5 is a top plan view of the trailer wherein the camper box is not present and showing a rotation plate.

FIG. 5A is a top plan view of the trailer wherein the camper box is not present and showing the rotation track.

FIG. 6 is a side elevational view of a circular shaped camper box rotation plate.

FIG. 7 is an exploded view of the cargo deck assembly that attaches to a tongue portion.

FIG. 7A is a perspective view of a forward pivot hinge.

FIG. 7B is a perspective view of a leg brace.

FIG. 7C is a perspective view of a rear pivot hinge.

FIG. 7D is a perspective view of a leg brace and pivot assembly.

FIG. 8 is a top plan view of the camper box prior to deployment of the dinette unit and sleeper unit.

FIG. 9 is a perspective view of a rail assembly when folded in upon itself.

FIGS. 10A-10F are side elevational views of an embodiment wherein a retractable tongue is provided.

FIG. 11A is a side elevation view of an embodiment of a hinged tongue wherein the hinged tongue is in a stored tongue position.

FIG. 11B is a side elevational view of the hinged tongue wherein the hinged tongue is in a deployed hinged tongue position.

FIG. 11C is an enlarged view of the coupling of the hinged tongue to the rectangular shaped support portion of the frame.

FIG. 11D is a top plan view of the hinged tongue.

FIG. 11E is a side elevational view of the hinged tongue in a locked position such that rotation thereof is not possible.

FIG. 11F is an enlarged view detailing the locking of the hinged tongue in the deployed position.

FIG. 12 is a side elevational view indicating the positioning of the camper box as it is being moved onto the trailer having a rotation track and in the direction of the arrow designated Z.

FIG. 12A is a side elevational view indicating the positioning of the camper box as it is being moved onto the trailer having a frame rotation plate and in the direction of the arrow designated Z.

FIG. 13 is a side elevational view of the camper box.

FIG. 14 is a top plan view showing a bed frame and box assembly disposed internal to the camper box as indicated by the dashed lines.

FIG. 15 is a front elevational view showing the bed frame and box assembly disposed internal to the camper box as indicated by the dashed lines.

FIG. 16 is a top view of the wherein the bed frame and bed box are deployed.

FIG. 17 is a front elevational view wherein the bed frame and bed box are deployed.

FIG. 18 is a perspective view of the bed box with a bed frame shown in dashed lines.

FIG. 19 is a perspective view of a bed frame.

FIG. 20A is a top plan view of a dinette unit prior to deployment

FIG. 20B is a front elevational view of the dinette unit prior to deployment.

FIG. 20C is a top plan view wherein the dinette unit is deployed and the roof of the camper box is not present.

FIG. 21A is a front elevational view of the dinette unit when deployed and nested in the rail assembly.

FIG. 21B is a top view of the dinette unit when deployed and nested in the rail assembly.

FIG. 22 is a top plan view of the dinette unit without seating.

FIG. 23 is a side elevational view of the dinette unit.

FIG. 24 is a perspective view of a dinette unit wall.

FIG. 25 is a perspective view of the dinette unit with a table disposed therein.

FIG. 26 is a perspective view of the dinette unit wherein the table is supported on benches.

FIG. 27 is a perspective view of the dinette unit wherein a hammock is deployed.

FIG. 27A is an enlarged view of portion K of FIG. 27 detailing the detachable side rails for the hammock.

FIG. 28 is a top plan view of the camper box showing a galley wherein the roof portion covering the galley is not present.

FIG. 29 is a front elevation view of a kitchen countertop in a retracted position taken along line S-S of FIG. 28.

FIG. 30 is a front elevational view of the kitchen countertop in an extended position taken along line S-S of FIG. 28.

FIG. 31 is a front elevational view of the galley in a stored position.

FIG. 32 is a front elevational view of the galley of FIG. 31 in a deployed position.

FIG. 33 is a top plan view detailing a shower and toilet unit wherein the roof of the camper box is not present.

FIG. 33A is a sectional view a portion of the floor taken along line T-T detailing passages disposed beneath a floor for accommodating wiring and tubing.

FIG. 34A is a bottom plan view of a rack assembly for extending the dinette unit and the bed frame and box assembly and prior to extension.

FIG. 34B is a bottom plan view of FIG. 33A after extension of the rack assembly.

FIG. 34C is a side elevational view of a central gear of the rack assembly.

FIG. 35 is a bottom plan view of a hand crank deployment assembly.

FIG. 35A is a side elevational view of a lifter gear for raising and lowering a lifter post.

FIG. 36 is a bottom plan view of another embodiment of the hand crank deployment assembly.

FIG. 36A is a front elevational view of the pop-up camper expansible through rotation wherein the lifter posts are in an extended position.

### DETAILED DESCRIPTION

In the detailed description like reference numbers are used to call out the same elements, parts and features throughout.

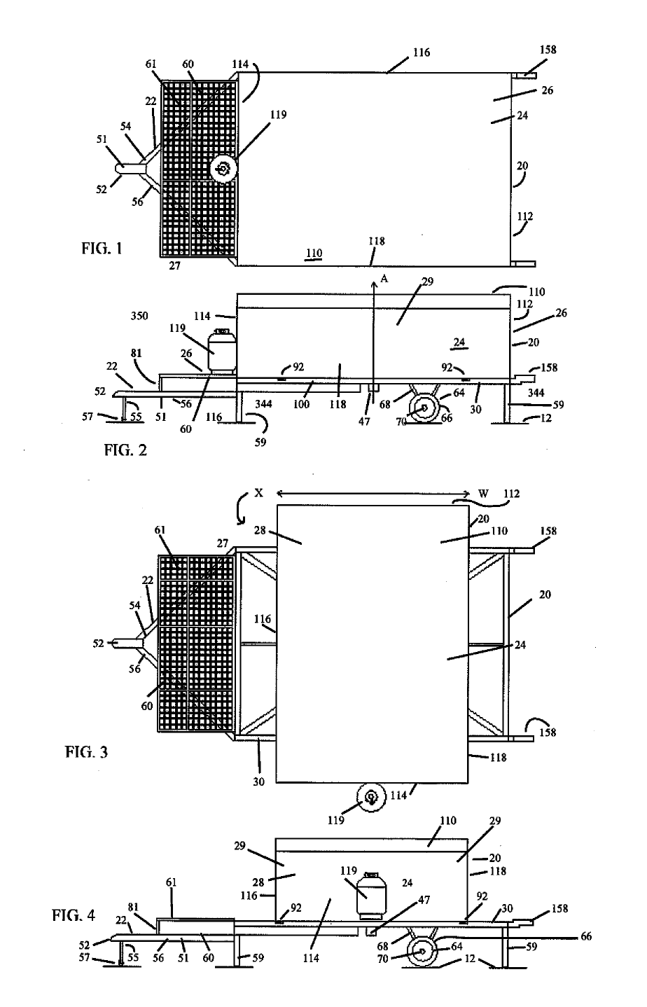

FIGS. 1-4 show one of the preferred embodiments of a pop-up camper expansible through rotation 20. The pop-up camper expansible through rotation 20 has a trailer 22 that is joined to a camper box 24. In FIGS. 1 and 2 the camper box 24 is in a transport position 26 wherein the camper box 24 is in line with the trailer 22 and thus the camper box 24 makes a zero degree (0°) angle relative to the trailer 22. In FIGS. 3 and 4 the camper box 24 is shown in a rotated position 28 wherein the camper box 24 is at a ninety-degree (90°) angle relative to the trailer 22. As shown in FIG. 3, the camper box 24 is rotated to the rotated position 28 after having been rotated in a counterclockwise direction as indicated by the arrow designated X. In other preferred embodiments the angles described above may be substantially zero degrees (0°) and substantially ninety degrees (90°).

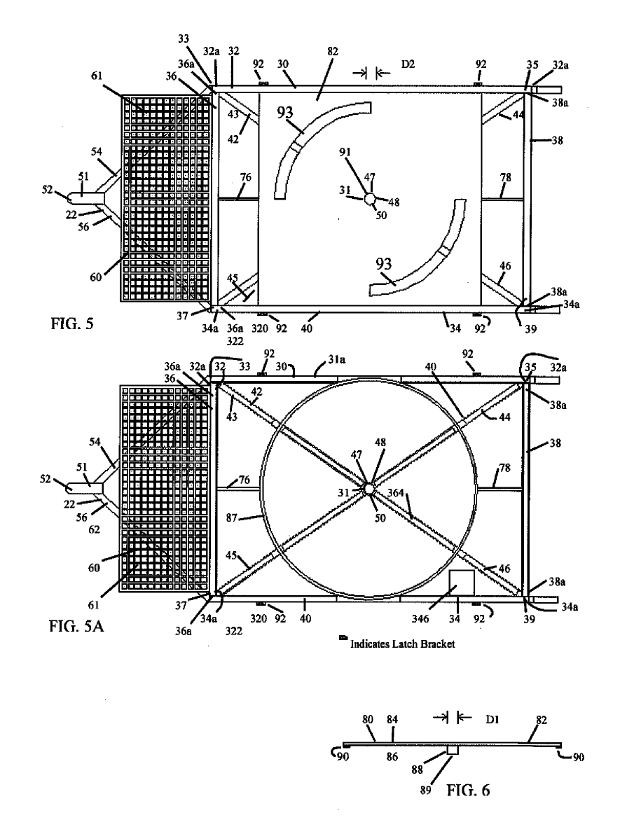

Turning now to FIG. 5 the trailer 22 comprises a frame 30 having a first support member 32 with a pair of opposed first support member ends commonly designated 32a, and a second support member 34 with a pair of opposed second support member ends commonly designated 34a. The frame 30 also has a third support member 36 with a pair of opposed third support member ends commonly designated 36a, and a fourth support member 38 with a pair of opposed fourth support member ends commonly designated 38a.

As shown, one of the first support member ends 32a is joined with one of the third support member ends 36a at a first corner 33, and the other first support member end 32a is joined with one of the fourth support member ends 38a at a second corner 35. One of the second support member ends 34a is joined with the other one of the third support member ends 36a at a third corner 37, and the other second support member end 34a is joined with the fourth support member ends 38a at a fourth corner 39. The first and second support members 32, 34 are substantially parallel, and the third and fourth support members 36, 38 are substantially parallel, such that together they form a support body 40 having a generally rectangular shape. The above-described first, second, third and fourth support members 32, 34, 36, 38 may be joined with bolts, welds, rivets and other suitable fasteners, and may be constructed from wood, steel, bamboo or other suitable materials and may have a rectangular cross section.

The frame 30 further includes a cross support frame 42 having a first cross member 43 that is joined with the first corner 33 and a pivot shaft housing 47. The cross support frame 42 further includes a second cross member 44 that is joined with the second corner 35 and the pivot shaft housing 47, a third cross member 45 that is joined with the third corner 37 and the pivot shaft housing 47, and a fourth cross member 46 that is joined with the forth corner 39 and the pivot shaft housing 47. Thus, together the first, second third and fourth cross support members 43, 44, 45 and 46 are joined to the pivot shaft housing 47 form the cross support frame 42 such that it has a cross shape or an X-shape as shown. As shown, the pivot shaft housing 47 is positioned at substantially the center 31 of the frame 30 and this advantageously provides for a more even distribution of a load generated by the camper box 24.

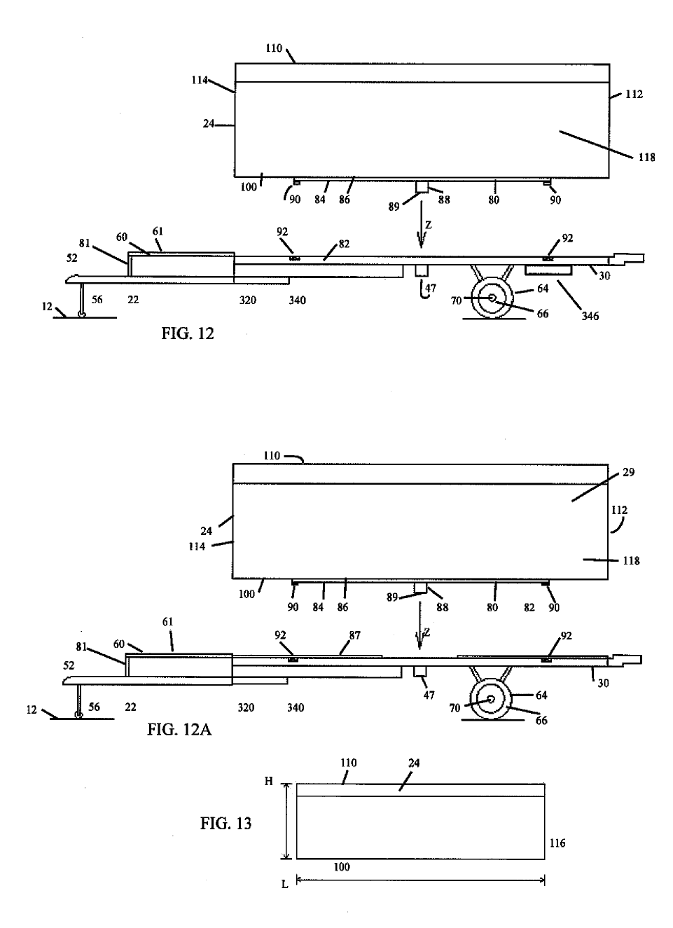

As shown in FIGS. 4, 5, 5A and 6, the pivot shaft housing 47 has a pivot shaft housing opening 48 that is adapted to receive a pivot shaft 88 (shown in FIGS. 6 and 12 and 12A) therein. The pivot shaft 88 has a pivot shaft opening 89. In one of the preferred embodiments there is a ball bearing assembly 50 mounted internal to the pivot shaft housing recess 48 to facilitate rotation.

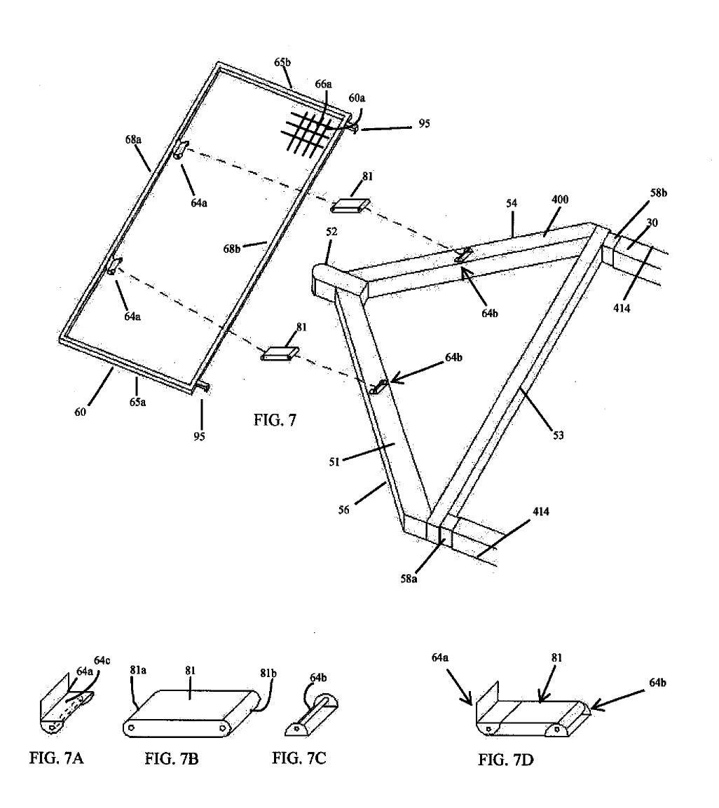

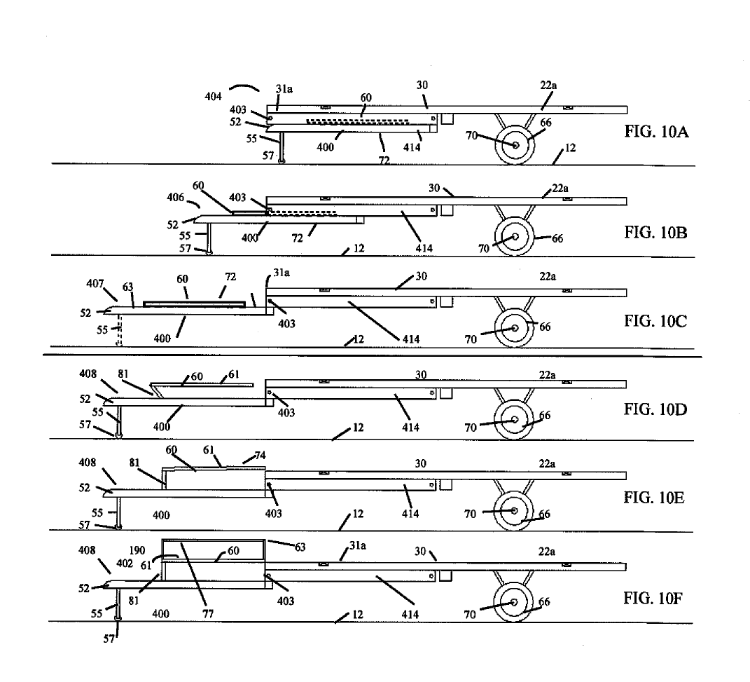

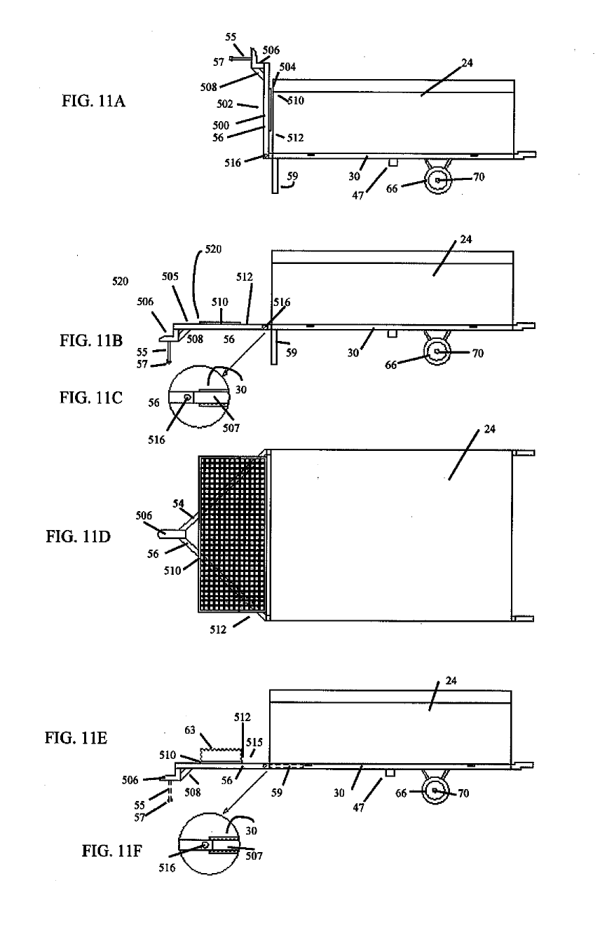

As shown in FIGS. 7, 8, and 10A-F, the frame 30, in one of the preferred embodiments, engages with a tongue 400 that is disposed below the frame 30. The tongue 400 is extendable and retractable and includes a tow portion 51 having a coupler 52, a first tow bar 54, a second tow bar 56, and a third tow bar 53, joined to one another and arranged in a generally triangular shape. Short tow bars 58a and 58b extend from the tow bar 53 substantially parallel with each other, to be described presently. The above joining may be made with bolts, welds, rivets and other suitable fasteners. In one of the preferred embodiments the coupler 52 is adapted to receive therein a tow ball (not shown) mounted on a vehicle (not shown). The use and manufacture of tow balls and couplers 52 is well known to those having ordinary skill in the art and therefore is not described in greater detail herein. The tow portion 51 also has a trailer support 55 for supporting the tow portion 51 on the ground 12 (shown for example in FIG. 10A). The trailer support 55 may be equipped with a support wheel 57 that contacts the ground 12. Trailer supports 55 and their use and construction are well known to those having ordinary skill in the art and are therefore not described herein in detail. In addition, as shown in FIGS. 2 and 4 variable length braces 59 are joined to the frame 30 and are for providing additional support to the pop-up camper expansible through rotation 20. A rear tail light assembly 158 extends from the frame 30 about eleven (11) inches, and is about one inch higher than the frame 30 such that it is substantially level with the base 100 of the camper box 24 (the base 100 is shown, for example, in FIG. 12).

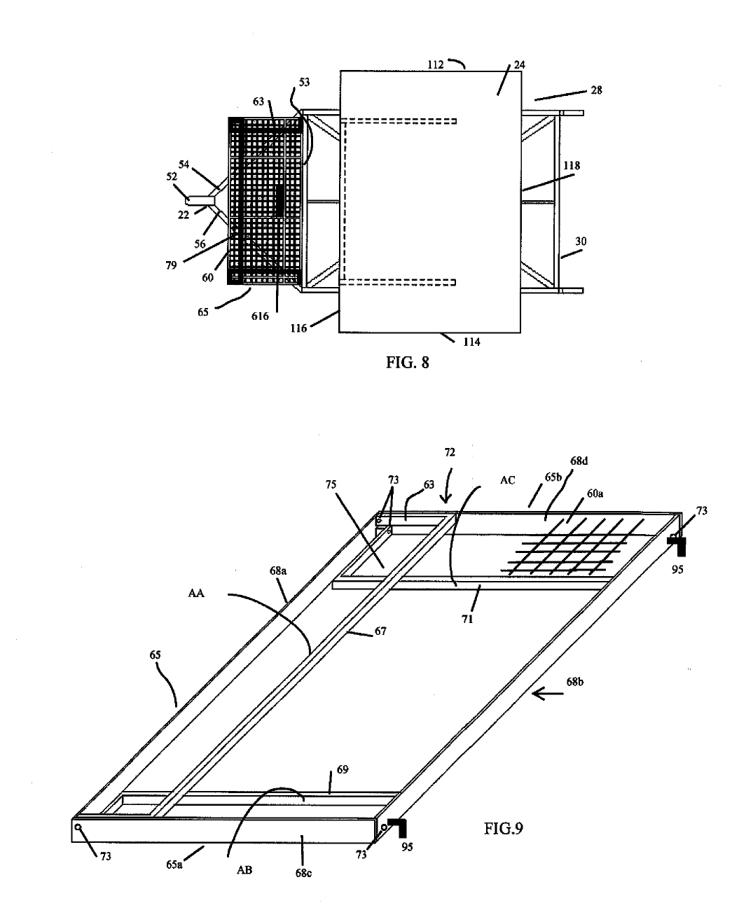

A cargo deck 60 is provided (See FIGS. 1, 7, 8, 9). The cargo deck 60 may be made of aluminum, bamboo, high density plastic, or other suitable material. The cargo deck 60 (see FIG. 9) includes a rail frame 65 having opposed first and second cargo frame bars 68a, 68b and opposed third and fourth cargo frame bars 65a and 65b, a rail assembly 63 (to be described presently), and a surface 66a that is embodied as a wire grid 60a. Cargo deck latches 95 are situated on second cargo frame bar 68b and extend in a direction away from the second cargo frame bar 68b about 4 inches in one of the preferred embodiments, and they enable the cargo deck 60 to latch onto the third tow bar 53 in a retracted cargo deck position 72 (FIG. 10C), and to the third support member 36 of the frame 30 an extended cargo deck position 74 (FIG. 10E). The cargo deck 60 may also include a cargo deck roller 616 (best shown in FIG. 8) to assist in the deployment of a dinette unit 160 as will be described presently.

The cargo deck 60 is capable of being moved from a retracted cargo deck position 72 (see FIG. 10C) wherein the cargo deck 60 is supported on the first and second tow bars 54, 56, to an extended cargo deck position 74 wherein the cargo deck 60 is supported on cargo deck leg braces 81 (see FIGS. 7, 7A-D and 10E) and elevated with respect to the first and second tow bars 54, 56. The cargo deck 60, that is capable of being moved, functions as a traditional means of carrying luggage, camping equipment, and other camping necessities (not shown) in the retracted cargo deck position 72 during travel, but in the extended cargo deck position 74 it provides a foundation for the full deployment of dinette unit 160, as will be described presently. As shown in FIGS. 7, 7A-D, the cargo deck 60 is secured to the tow portion 51 in the following manner: generally L-shaped first pivot flanges 64a are attached through bolts, welds, or other fasteners to the leading edge of the first cargo frame bars 68a of cargo deck 60 about two feet (in one of the preferred embodiments) in from corners formed where the first tow bar 54 meets the third tow bar 53 and the second tow bar 56 meets the third tow bar 53, with the flat or horizontal portions 64c of these pivot flanges 64a being situated under the first crossbar 68a, to best carry the weight of anything resting atop the cargo deck 60. The first ends 81a of cargo deck leg braces 81 connect to pivot flanges 64a through a bolt or pin/hole arrangement, thus allowing cargo deck leg braces 81 to pivot from a generally horizontal to a generally vertical position. Similarly, second pivot flanges 64b are fastened to the upper surface of the first and second tow bars 54, 56 and receive the second ends 81b of the cargo deck leg braces 81 through the same bolt/hole arrangement as previously mentioned.

Shown in FIGS. 8, 9 and 10F is a rail assembly 63 that nests within the cargo deck 60, and in particular nests within the opposed first and second cargo frame bars 68a, 68b, and opposed third and fourth cargo frame bars 65a, 65b of the rail frame 65. A first rotatable support rail 67 is joined to the opposed third and fourth cargo frame bars 65a, 65b with rail pivot pins commonly designated 73. Second and third rotatable support rails 69, 71 are each pivotally connected to the opposed first and second cargo frame bars 68a, 68b with pivot pins 73. The rail assembly 63 is movable between a lowered position 75 (shown in FIGS. 9 and 10A-C) and an elevated position 77 (shown in FIGS. 10F, 20B and 21A). The rail assembly 63 shown in FIG. 9 is moved to the elevated position 77 in the following manner. The first rotatable support rail 67 is rotated in the direction of the arrow designated AA until it is substantially perpendicular to the rail frame 65. Next, the second rotatable support rail 69 is rotated in the direction of the arrow designated AB until it is substantially perpendicular to the rail frame 65. Then, the third rotatable support rail 71 is rotated in the direction of the arrow designated AC until it is substantially perpendicular to the rail frame 65, completing the elevation of the rail assembly 63 into the elevated position 77. It is pointed out that in FIG. 8 that the wire grid 60a has a rail assembly recess 79 that matches the shape of the rail assembly 63 such that when the rail assembly 63 is in the lowered position 75 it is substantially flush with the cargo deck 60. The rail assembly 63 will be in the lowered position 75 when, for example, the camper box 24 is rotated. The rail assembly 63 may be in the elevated position 77 when the pop-up camper expansible through rotation 20 is being towed so that luggage and cargo may be placed on the cargo deck 60 and tied or otherwise secured to the rail assembly 63. When both the cargo deck 60 is in the extended cargo deck position 74 and the rail assembly 63 is in the elevated position 77, they help support, guide and secure the full deployment of the dinette unit 160, as will be described presently.

The tongue 400 (FIGS. 7, 10A-F) is slidably received along trailer rails 414 between a fully retracted (storage) position 404, a partially extended position 406, and an extended travel position 407 (FIG. 10C), and a deployed position 408 once at the campsite (FIGS. 10D-F). The trailer rails 414 are joined to and disposed below the frame 30 and support the tongue 400. The tongue 400 is supported in front on a trailer support 55 having a support wheel 57 that aids in retraction/deployment. The short tow bars 58a and 58b (FIG. 7) of tongue 400 slide along trailer rails 414, which are welded or otherwise joined to frame 30 about 5 inches below and parallel with the top surface 31a of the frame 30. When the tongue 400 is in the retracted position 404, the tongue 400 is advantageously disposed in an out of the way position such that it poses no tripping hazard and storage space requirements are advantageously decreased.

To deploy and extend the tongue 400, the camper applies a force on the coupler 52 that is joined to trailer support 55 and support wheel 57. Tongue 400 slides along the trailer rails 414 until the tongue reaches the fully extended position 407. Bolts 403 or other suitable fasteners secure the fully extended tongue 400 to the frame 30 when it is in the fully extended position 407, thus preparing the trailer for towing and for deployment of the dinette unit 160 in camping mode wherein the tongue 400 is in a deployed position 408. Once the tongue 400 is fully extended, the camper can elevate the rail assembly 63 to the elevated position 77 to aid in securing of baggage (not shown) during towing. Once at the campsite, the camper can then elevate the entire deck 60 into the extended cargo deck position 74 (FIG. 10D-F), thus providing a foundation for deployment of the dinette unit 160. To return to the tongue 400 to the extended travel position 407 and then to the retracted position 404, all of the steps described above are reversed.

FIGS. 11A-11F are views of another preferred embodiment wherein a hinged tongue 500 is provided. FIG. 11A is a side elevation view wherein the hinged tongue 500 is in a hinged tongue stored position 502 and held in a vertical position with a connector 504, for example a pin, spring, clamp, hook or other suitable arrangement. As shown in FIG. 11B the hinged tongue 500 is in a fully deployed mode 505. The fold down camper box supports 59 are also deployed to support the weight of the camper box 24 in FIGS. 11A and 11B. The hinged tongue 500 is capable of being pivoted between the hinged tongue stored position 502 and the fully deployed mode 505 on a pair of hinged tongue pivot pins 516. As detailed in FIG. 11C and 11D the frame 30 houses support bars 507 and the hinged tongue pivot pins 516 extend through the first and second tow bars 54, 56 and the support bars 507 thus allowing the hinged tongue 500 to be pivoted. In FIGS. 11E and 11F the hinged tongue 500 is in a tow position 515. The first and second tow bar 54, 56 are partly received (telescopically) in the frame 30 and held in place with the hinged tongue pivot pins 516 such that the hinged tongue is unable to pivot on the hinged tongue pivot pins 516. It is pointed out that in FIGS. 11A-11F the propane tank 119 is not shown, as it is removed in advance by the owner for storage, safety, and reuse, for example for home grilling purposes.

As shown in FIGS. 11A and 11D the first and second tow bars 54, 56 joined to an L-shaped coupler 506. A brace member 508 is joined to the L-shaped coupler 506 and the first and second tow bars 54, 56 and provides additional support for the L-shaped coupler 506. There is also a first cargo deck 510 and a second cargo deck 512, and each is mounted on the first and second tow bars 54, 56. The first cargo deck 510 is disposed on the first and second tow bars 54, 56 such that it is elevated with respect to the second cargo deck 512. This ensures the camper box 24 is freely rotatable by the camper. In addition and as shown in FIG. 11E, the first cargo deck 510 may be equipped with the previously described rail assembly 63.

First cargo deck 510 is riveted or otherwise firmly attached to the first and second tow bars 54, 56, and is substantially flush with the base 100 of camper box 24. This provides a firm and broad foundation for deployment of a dinette unit 160, as previously mentioned.

Finally, in a third embodiment, shown in FIG. 11B and with a dashed reference number line for a fixed tongue 520 is shown. The fixed tongue 520 is substantially identical to the hinged tongue 500, but the hinges 516 are not present. The end of the first tow bar 54 would be welded, riveted, or otherwise rigidly attached to the first corner 33 of frame 30; similarly, the end of the second tow bar 56 would be rigidly attached to the third corner 37 of frame 30. Both the hinged tongue 500 and fixed tongue 520 advantageously use less material than the retractable tongue 400 and provide for a firmer foundation for the dinette.

As shown in FIGS. 1 and 4, the trailer 22 further includes a wheel assembly 64 having a pair of wheels 66 that contact the ground 12. The pair of wheels 66 is mounted on an axle 70 joined to the frame 30 of the trailer 22. Joining wheels 66 to the frame 30 of a trailer 22 is well known to those having ordinary skill in the art and therefore will not be described in further detail herein. There may be springs and shock absorbers commonly designated 68 disposed between the axle 70 and frame 30 to absorb shock and support the frame 30. The use and installation of springs and shock absorbers 68 are well known to those having ordinary skill in the art and are therefore not described in greater detail herein. The frame 30 is built about four to six inches higher than a standard pop-up camper frame that is presently in use so that the camper box 24 is elevated with respect to the pair of wheels 66 and may be rotated over the pair of wheels 66.

As shown in FIGS. 6, 12, 12A, a camper box rotation plate 80 having opposed first and second plate sides 84, 86 is joined to the base 100 of the camper box 24. In one of the preferred embodiments the camper box rotation plate 80 has a generally circular shape and has a diameter of about 6 feet 10 inches in one of the preferred embodiments such that it is capable of fitting within the first, second, third and fourth support members 32, 34, 36, and 38. The camper box rotation plate 80 has a center point 85 located at the center thereof. Extending from the second plate side 86 proximal the center point 85 of the camper box rotation plate 80 is the pivot shaft 88 having the pivot shaft opening 89 that, in one of the preferred embodiments, has a cylindrical shape. In other preferred embodiments effecting rotation may be developed depending on cost and other factors, but these embodiments will generally be circular shaped such that weight is distributed across a broad area of the frame 30 and the floor 101 of the camper box 24 is structurally supported. The camper side 84 of the camper box rotation plate 80 is joined to a base 100 of the camper box 24.

As shown in FIGS. 5 and 12, the camper box rotation plate 80 is positioned on a frame rotation plate 82 that has a generally square shape in one of the preferred embodiments. The frame rotation plate 82 is recessed relative to the frame 30 and is joined to the frame 30. The frame rotation plate 82 has a centrally located frame rotation plate opening 91 sized to allow the pivot shaft 88 to pass there through. First and second stabilizer members 76, 78 are each joined to the frame 30 and the frame rotation plate. The camper box rotation plate 80 and the frame rotation plate 82 are, in one of the preferred embodiments, made of a low friction material, for example Teflon or UHMW plastic, and assist the ball bearing assembly 50 in the rotation of the camper box 24. Camper box stops 90 extend from the camper box rotation plate 80. The camper box stops 90 are disposed in a pair of spaced apart arc shaped slots 93 defined in the frame rotation plate 82. Each of the arc shaped slots 93 is shaped so as to make about a ninety degree arc. The camper box stops 90 allow for ninety degrees of rotation of the camper box 24. In other preferred embodiments the arc shaped slots 93 may be embodied to be more or less than ninety degrees depending on the application.

As shown in FIGS. 5A and FIG. 12A the frame rotation plate 82 is replaced with a rotation track 87 that is supported on the cross support frame 42 and the first support member 30 and second support member 34. In this embodiment the camper box stops 90 are received in the rotation track 87. The camper box 24 is rotatable on the rotation track 87. It is pointed out that in FIGS. 2, 4, 5 and 5a there are latches 92. The latches 92 are for securing the camper box 24 to the frame 30 when it is in either the transport position 26 or the rotated position 28.

The pivot shaft 88 has a pivot shaft diameter designated D1 in FIG. 6. As shown in FIG. 5, the pivot shaft housing opening 48 defined by the pivot shaft housing 47 has an internal pivot shaft housing diameter designated D2 that is greater than D1. The pivot shaft housing 48 is adapted to receive the pivot shaft 88 therein. The pivot shaft 88 is positioned inside the pivot shaft housing recess 48 such that the camper box 24 is rotatable relative to the frame 30. The manner of positioning the pivot shaft 88 in the pivot shaft housing 47 is shown in FIG. 8 wherein the arrow designated Z indicates the directional movement of the pivot shaft 88 into the pivot shaft housing 47. Thus, the camper box 24 is capable of being rotated relative to the frame 30 in a counterclockwise direction (designed by the arrow X in FIG. 3) and about a central axis designated A in FIG. 2 to from the cross shape shown in FIG. 3. It is pointed out that the pair of wheels 66 does not interfere with the rotation of the camper box 24 because the base 100 of the camper box 24 is supported above the pair of wheels 66.

The large diameter of the camper box rotation plate 80 advantageously distributes the load of the camper box 24 to the first, second, third and fourth corners 33, 35, 37, and 39 of the frame 30 to provide for enhanced support and stability of the camper box 24.

Turning now to FIG. 13 the camper box 24 when in the transport position 26 has a length of about 10 (ten) feet and designated L, and a height of about 3 (three) feet and designated H, and a width shown in FIG. 3 of about 7 (seven) feet as and designated W. In other preferred embodiments the principles of this design are usable in connection with 12 (feet) to 18 (feet) long camper boxes for use by those camping enthusiasts owning or using trucks, sport utility vehicles (SUVs), and similar vehicles for hauling. And, in other preferred embodiments the rotatable camper box 24 may be used in connection with fifth wheel type campers and fixed wall campers. As will be described presently, the rotatable camper box 24 advantageously provides for significantly improved internal configuration that allows the camper box 24 to be more user-friendly as compared to campers currently in use.

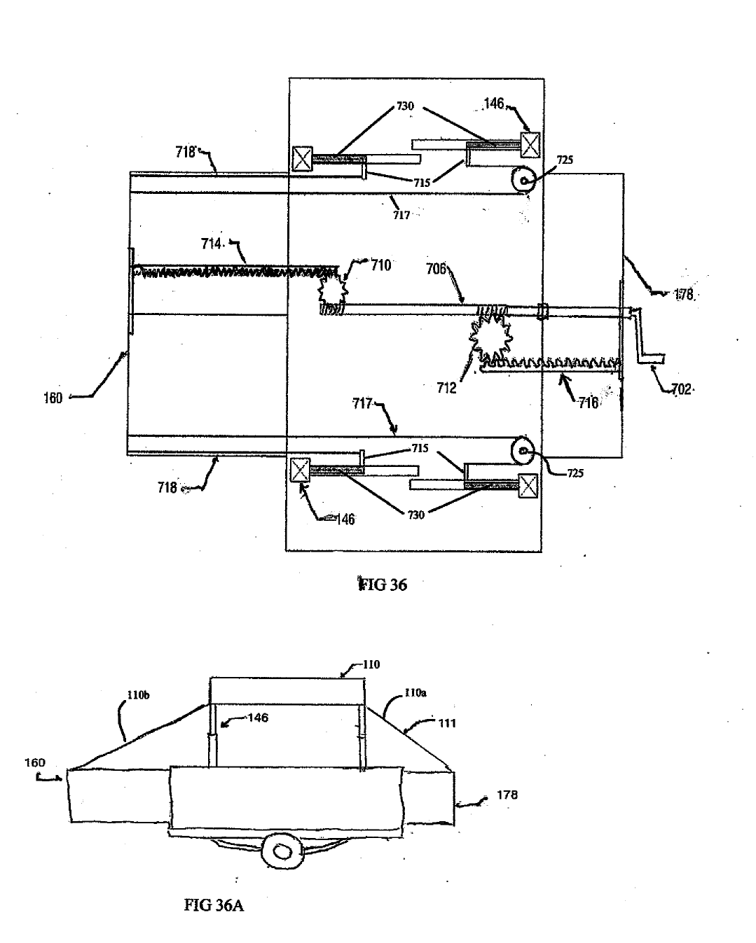

As shown in FIG. 3, the camper box 24 has a roof 110 that is disposed opposite the base 100. The camper box 24 further includes a door side wall 112 that is joined to the base 100 that faces a galley side wall 114 that is joined to the base 100, and a dinette side wall 116 that faces a bed side wall 118 joined to the base 100. The roof 110 is joined to the door, galley, dinette and bed side walls 112, 114, 116, 118. As shown in FIG. 36A, when the camper box 24 is fully deployed there is a sleeper roof 110a and a dinette roof 110b each being made of a suitable tenting material 111. As shown in FIGS. 1-4 a propane tank 119 is supported on the galley side wall 114 such that it rotates with the camper box 24. For the sake of clarity the propane tank 119 is not shown in all of the drawing figures.

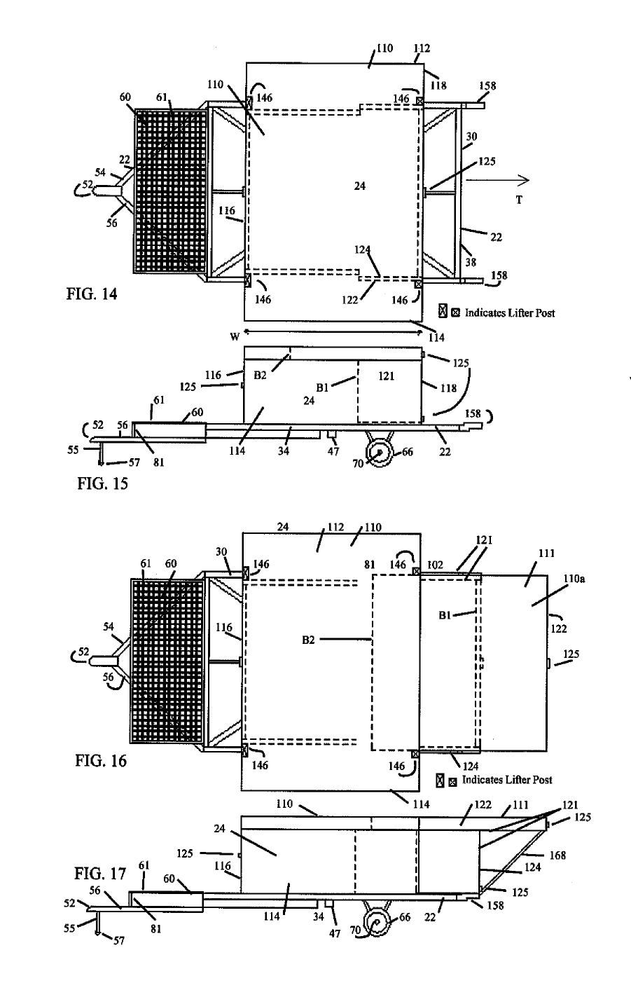

FIGS. 14-19 are directed to the bed side wall 118 and show a bed frame and box assembly 121 having a bed frame 122 and a bed box 124. In FIGS. 15 and 16 the dashed line designated B1 indicate the position of the position of a bed box 124 before and after having been deployed out of the bed side wall 118. Similarly, the dashed lined designated B2 indicate the position of a bed frame 122 before and after having been deployed out of the bed side wall 118. The bed frame and bed box 122, 124 are pulled in a direction away from the bed side wall 118 and in the direction of the arrow designated T in FIG. 14. Handles, commonly designated 125, are mounted to the bed side wall 118 to allow the bed frame and box 122, 124 to be manually pulled out of the camper box 24. In one of the preferred embodiments about 18 inches of the frame 30 are exposed prior to this deployment and serves as partial foundation for supporting the bed box 124. In one of the preferred embodiments the bed frame 122 is sized to accommodate a queen-sized bed. As shown in FIG. 16 there is a sleeper roof 110a that covers the bed frame and box assembly 121.

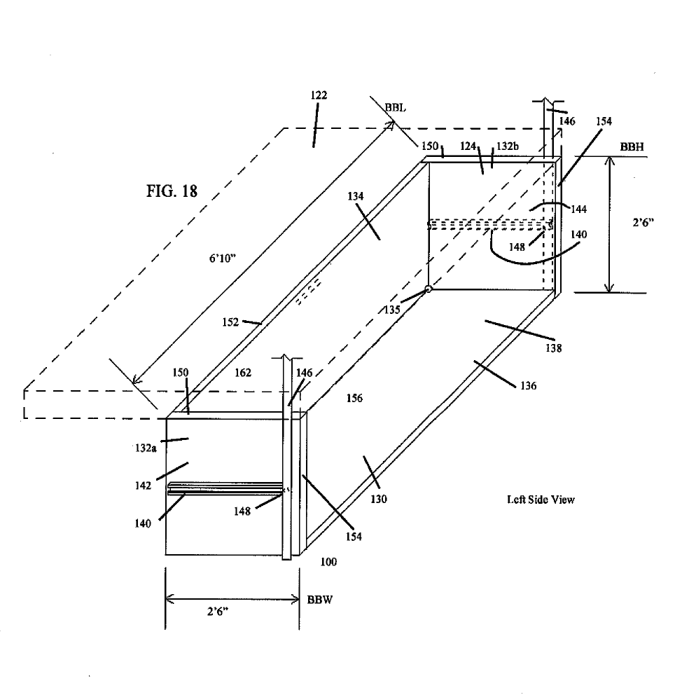

As shown in FIG. 17, the bed box 124 is positioned between the bed frame 122 (shown in phantom lines) and the frame 30 such that it is disposed beneath the bed frame 122. As shown in FIG. 18, In one of the preferred embodiments the bed box 124 has a height designated BBH of about 30 inches, a length designated BBL of about 82 inches, and width designate BBW of about 30 inches. The bed box 124 has a bed box floor 130, a pair of opposed first and second bed box side panels 132a and 132b joined to the floor 130, and a hinged panel 134 joined to the floor 130 by at least one hinge 135. The bed box 124 has a bed box opening 136 defined by the floor 130, the opposed bed box side panels 132a, 132b, and the hinged panel 134. The bed box opening 136 advantageously allows access to a bed box cavity 138 defined in the bed box 124. Campers are able to advantageously place their luggage (not shown) and other equipment (not shown) in the bed box cavity 138. The hinged panel 134 is hinged to the bed box floor 130 and may be equipped with a lock (not shown) to allow campers to access the inside of the camper box 24 during storage thereof.

There is a rail 140 mounted on the outer surfaces 142, 144 of the each first and second bed box side panels 132a, 132b. Lifter posts, commonly designated 146, are mounted to the base 100 of the camper box 24. The lifter posts 146 are for raising the roof 110 of the camper box 24, that is, as the lifter posts 146 are raised so is the roof 110. Casters, commonly designated 148, are joined, for example with a weld, to the lifter posts 146 such that the casters 148 are received in the rails 140. Weather seals commonly designated 150 and which may be made of rubber or other suitable material are joined to the bed box 124 along the top edges 152 and junctions 154 with the camper box 24. The weather seals 150 are for keeping out drafts and moisture.

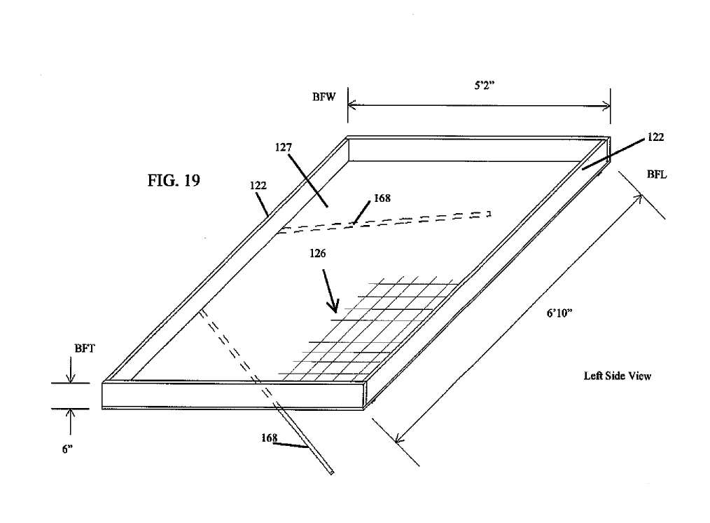

The bed frame 122 shown in FIG. 19 has a rectangular shape, and has a bed frame width designated BFW of about 62 inches, a bed frame length designated BFL of about 82 inches, and a bed frame thickness designated BFT of about 6 inches in one of the preferred embodiments. When the bed frame 122 is stored internal to the camper box 24 it is supported on top of the bed box 124 and a dinette unit 160 (to be described presently) that is positioned internal to the camper box 24. To facilitate and guide deployment of the bed frame 122 bed rails (not shown) may be mounted on the bed box 124 and received in bed frame guides (not shown) joined to the bed frame 122. Additional guidance of the bed frame 122 may be provided by way of casters 148 joined on the lifter posts 146. UHMW plastic could be added at the contact between the bed frame 122 and the dinette 160 to facilitate movement. The bed frame 122 in one of the preferred embodiments slides out about 60 inches from the camper box 24 such that it is disposed vertically above the bed box 124. And, the bed frame 122 extends about 31 inches beyond the bed box 124 in one of the preferred embodiments. Support poles, commonly designated 168, are deployable from the bed frame 122 and are joined to and extend from a bed frame floor 127. When deployed the support poles 168 shown in FIGS. 17 and 19 extend from the bed frame 122 to the frame 30 and in particular to the rear tail light assembly 158, thus supporting the bed frame 122. In one of the preferred embodiments the bed frame 122 is sized to accommodate, for example an inflatable 60 by 80 inch queen mattress (not shown). In one of the preferred embodiments the bed frame 122 is advantageously made of light materials, for example aluminum. The bed frame floor 127 serves to keep out pests and can be constructed of a thin material. Cross-meshing that extends between all four sides of the bed frame 122 made of nylon cord or similar light material can be used as a box spring 126 with which to support a mattress (not shown).

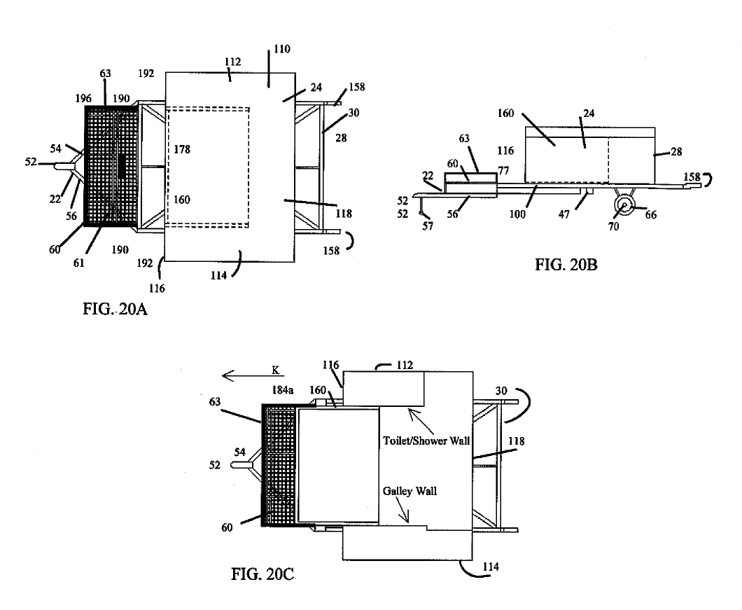

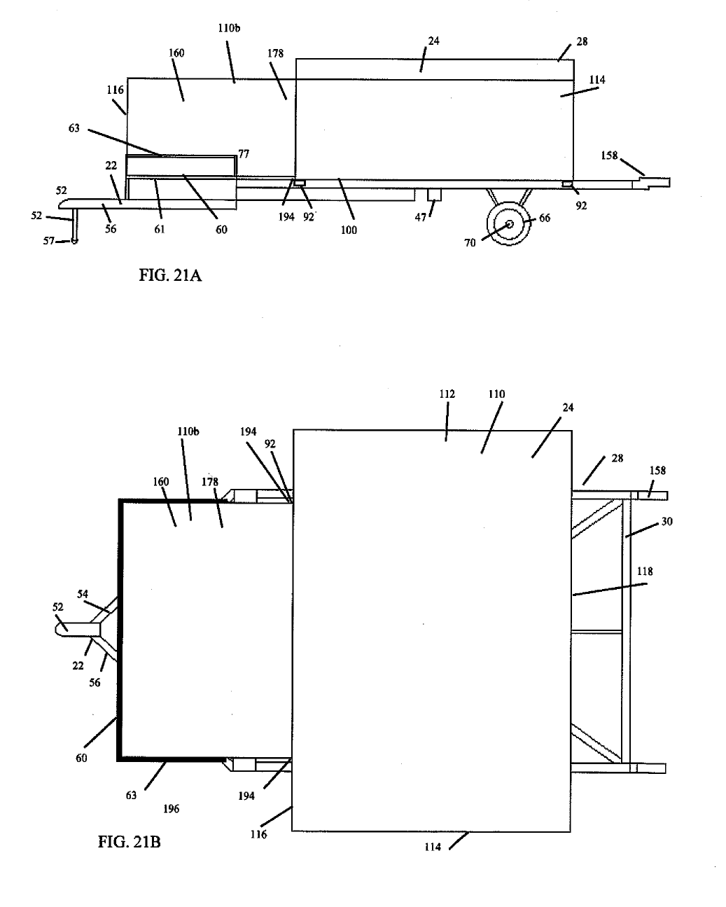

As shown in FIGS. 20A-20C, the camper box 24 further includes a dinette unit 160 that is reconfigurable to a sleeper unit 178. The dinette unit 160 is deployable from the dinette side wall 116. The method by which the dinette unit 160 is reconfigurable into the sleeper unit 178 and back to the dinette unit 160 by the person camping will be described presently. FIGS. 20A and 20C show the dinette and sleeper units 160, 178 in a stored position internal to the camper box 24. FIG. 20C shows the dinette and sleeper units 160, 178 deployed from the camper box 24. FIG. 21A is a front elevational view of the dinette unit 160 after it has been fully slid out of the camper box 24 (after having been moved in the direction of the arrow designated K in FIG. 20C). It is pointed out that the dinette unit 160 is positioned within the rail assembly 63 and the base 100 of the camper box 24 includes a floor 101.

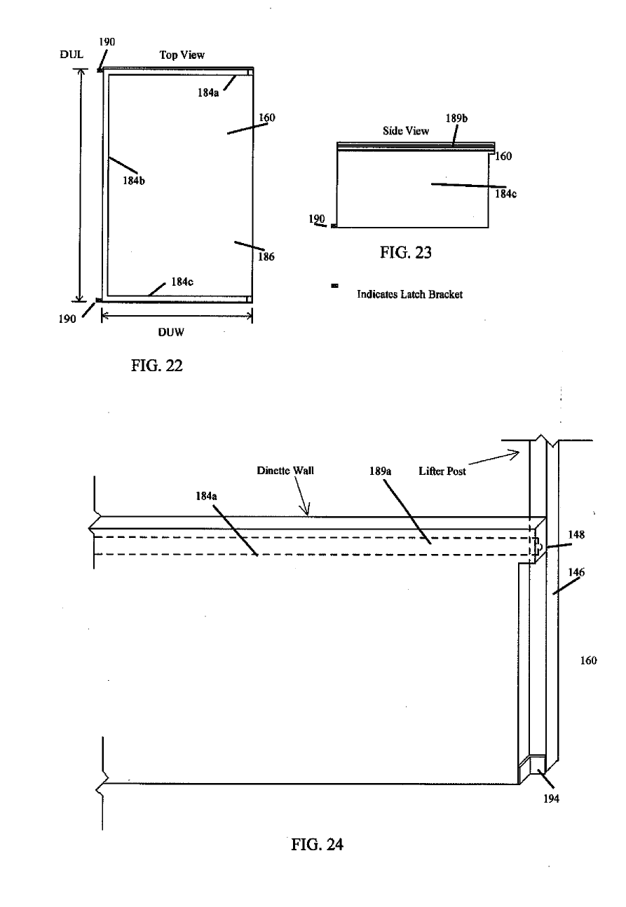

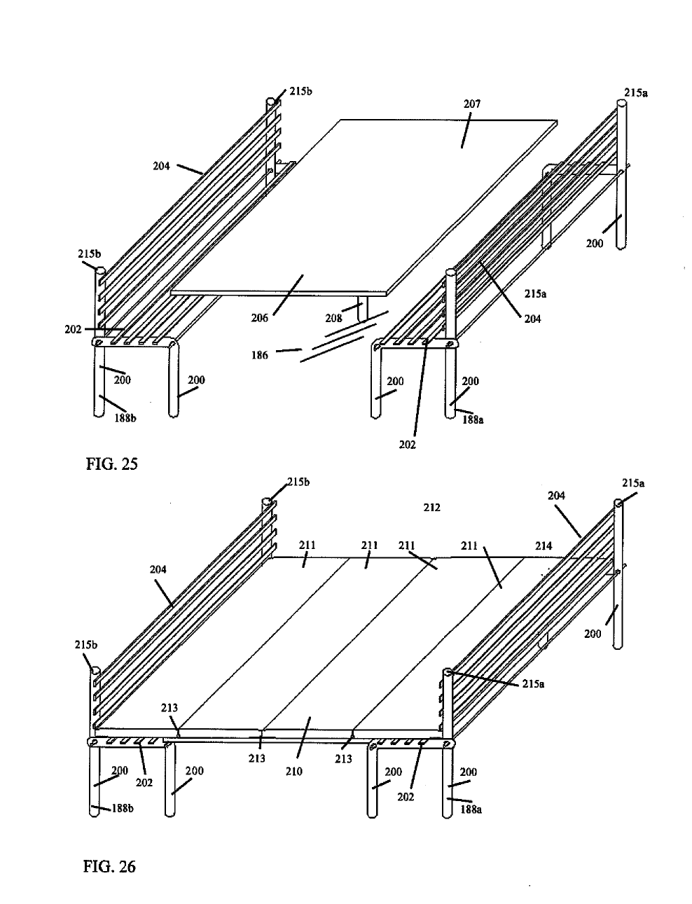

FIG. 22 is a top plan view of the dinette unit 160 without any seating. FIG. 23 is a left side elevational view of the dinette unit 160 and FIG. 24 is an elevational view of a dinette unit 184a detailing the joining thereof to a lifter post 146 and the dinette unit 160. In one of the preferred embodiments the dinette unit 160 has a dinette unit length designated DUL of about 76 inches and a dinette unit width designated DUW of about 54 inches. The dinette unit 160 also has a dinette floor 186, first, second and third dinette walls 184a, 184b and 184c and first and second seats 188a and 188b as shown in FIG. 25. In one of the preferred embodiments the dinette unit 160 is deployable such that it extends about 52 inches out over the trailer 22. In each of the preferred tongue embodiments, the cargo deck 60 does not interfere with the rotation of the camper box 24 and is substantially level with the base 100 of the camper box 24. The previously described latches 92 secure the camper box 24 to the frame 30 when it is in the rotated position 28 as shown. In addition, latch brackets 190 that may be rubber-cushioned brackets extend from the dinette unit 160 and are for securing the dinette unit 160 to the cargo deck 60 or trailer 22 when the dinette unit 160 is extended out of the camper box 24 so that the dinette unit 160 is stabilized. Catches 194 shown in FIG. 24 secure the dinette unit 160 to the camper box 24 where they meet the lifter posts 146. In addition, as shown in FIGS. 23 and 24, the dinette unit 160 has a first and second dinette rails 189a, 189b mounted on the first and third dinette walls 184a, 184c, and casters 148 mounted on the lifter posts 146 are positioned in the first and second dinette rails 189a, 189b. The first and second dinette rails 189a, 189b guide the dinette unit 160 as it is slid in and out of the camper box 24. As described previously, the cargo deck 60 has a cargo deck roller 616 (see FIGS. 8 and 20A) for further facilitating movement of the dinette unit 160.

It is pointed out that the cargo deck 60 when supported on the cargo deck legs 81 it is substantially level with the base 100 and/or floor 101 of the camper box 24. In another preferred embodiment, the act of pulling the dinette unit 160 out releases bars (not shown) that drop down and are anchored to the frame 30, thus providing additional support for the dinette floor 186.

The dinette unit 160 and the sleeper unit 178 are unique as shown in FIGS. 25-27. This is because the dinette unit 160 is designed such that it may be reconfigured into the sleeper unit 178 in a manner to be described presently.

In particular, the first and second seats 188a and 188b resemble park benches and have posts commonly designated 200 that may have a generally tubular shape. The first and second seats 188a, 188b have seat bottoms 202 and back supports 204. A table 206 having a table top 207 and a table leg 208 is also provided in the dinette unit 160. The table leg 208 is in one of the preferred embodiments removably mounted on the dinette unit floor 186 and to the table top 207. The table 206 may be about 40 inches by 57 inches in one of the preferred embodiments. The seat bottoms and back supports 202, 204 are made of nylon-rope meshing in one of the preferred embodiments. As shown in FIG. 26 the table 206 is capable of being lifted off table leg 208 and placed on the first and second seats 188a, 188b to thus form a dinette table bed 210. When the table 206 is placed on top of the first and second seats 188a, 188b inflatable upholstery, for example an air mattresses for cushioning may be placed on the dinette table bed 210 and in one of the preferred embodiments may be held in place with hook and loop fasteners, snaps or other suitable fasteners. In another preferred embodiment the first and second seats 188a and 188b may be provided with cushions 211 for seating and backing. The cushions 211 may be placed on the dinette bed 210 to form a mattress 212. The cushions 211 may be held together with fasteners 213 to form the mattress 212. The fasteners 213 may include snaps and hook and loop fasteners.

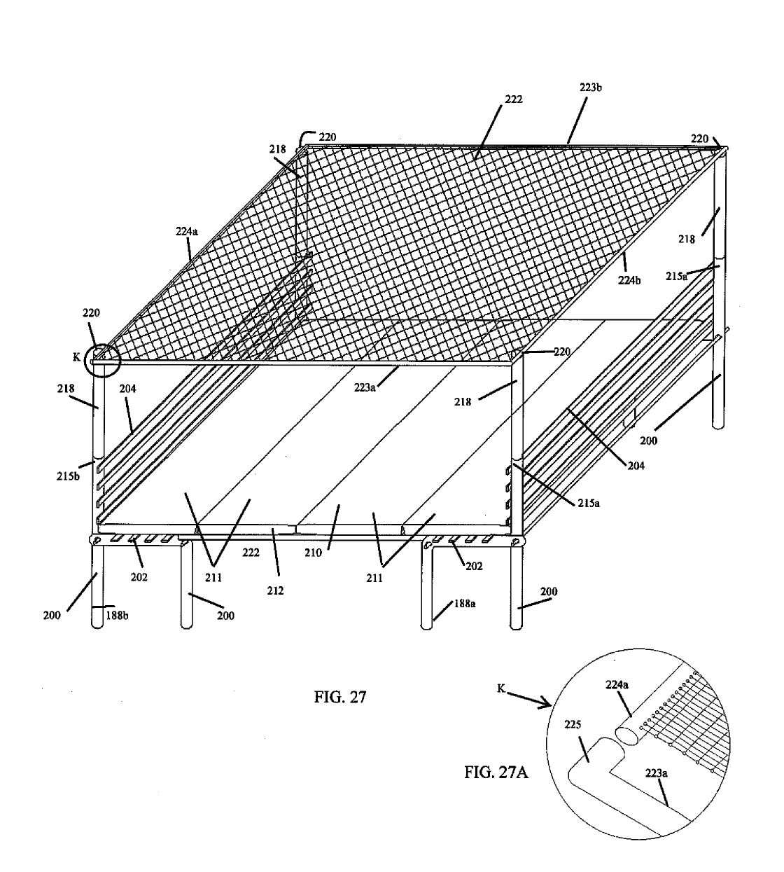

As shown in FIG. 27, the first bench 188a has a first pair of back rest posts 215a and the second bench 188b has a second pair of back rest posts 215b. Inserts commonly designated 218 are removably mounted on the first and second pairs of back rest posts 215a, 215b. For example, the inserts 218 may be fitted over the first and second pairs of back rest posts 215a, 215b. Notches 220 are defined in the inserts 218 to accommodate a hammock 222 that is strung tightly from the first and second pairs of back rest posts 215a, 215b. The hammock 222 includes straight opposed bars 224a, 224b between which is strung net-like hammock meshing 222a in, and hammock meshing 222a and the use and installation thereof is well known to those having ordinary skill in the art. In addition, opposed first and second cross braces 223a, 223b are provided, and they have hollow L-shaped end portions commonly designated 225 as shown in FIG. 27A. FIG. 27A is an enlarged view of the portion K of FIG. 27. The hammock meshing 222a may also be strung between the first and second cross braces 223a, 223b. The L-shaped end portions 225 are sized such that the opposed ends of the straight bars 224a and 224b are capable of being received in the L-shaped end portions 225 so as to form a hammock frame 226. This arrangement adds stability to the hammock 222 and takes some of the stress off of the inserts 218. When not in use the hammock frame 226 can be disassembled and rolled into a cylindrical shape for convenient storage. The hammock 222 which is like a mesh box spring may be comfortable enough for some sleepers, but if not, an air mattress (not shown) may be positioned thereon to provide more cushioning effect. After the dinette tent roof 110b shown in FIG. 21A is raised to between about 6 (six) feet 10 (ten) inches to about 7 (seven) feet, there is sufficient room to accommodate the above-described type bedding arrangement. Thus, the dinette unit 160 advantageously has a dual utility and is capable of being transformed into the sleeper unit 178 by the person camping.

The first and second benches 188a, 188b are firmly anchored to the dinette floor 186 and are sufficient durable to support people camping as they swing themselves in and out of bed. In other preferred embodiments lifts (not shown) are provided for in the camper box 24, for example a Hoyer lift, to lift a disabled camper into a bed, such lifts being well known to those having ordinary skill in the art and are not described herein in greater detail.

In addition, due to the cross-shape and the elbow junctions associated with the tenting and known to those having ordinary skill in the art, in one of the preferred embodiments the dinette and sleeper units 160, 178 are deployed before the roof 110, sleeper roof 110a and a dinette roof 110b are raised and lowered on the lifter posts 146. The dinette and sleeper units 160, 178 are partly enclosed by a suitable tent material 111. The deployment of the bed and dinette units 160, 178 pulls the folded soft-roof and sidewall tenting material 111 (see FIG. 36A) out from deep inside the camper box 24. Soft roofing and bracing covers the dinette unit 160 and the bed unit 178. Soft roofing and the method of supporting soft roofing are well known to those having ordinary skill in the art and are therefore not described in detail herein. There are inverted U-shaped braces (not shown) that may be manually fitted into slotted floor brackets (not shown) proximal the dinette and sleeper units 160, 178. Inverted U-shaped brackets and methods of supporting them are well known to those having ordinary skill in the art and are not described herein in detail. In one of the preferred embodiments thin plastic sheets are sewn into the tent material 111 such that pressure associated with lowering the roof 110 results in all tenting material 111 to collapse into the camper box 24. The thin plastic sheets may have the additional advantage of reflecting more heat away from inside the camper box 24.

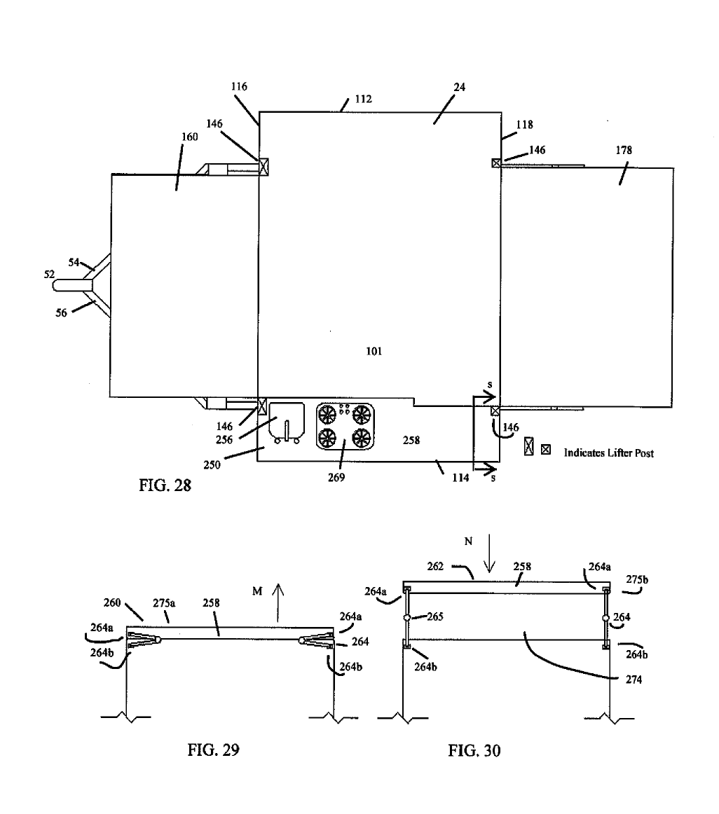

A galley 250, shown in FIGS. 28-32, is installed against the galley side wall 114 of the camper box 24. In FIG. 28 the roof 110 of the camper box 24 is not shown so that the details of the galley 250 are visible. The galley 250 has a cupboard 252 that is, in one of the preferred embodiments, about 18 inches deep and have a length of about 30 inches and are disposed proximal the bed box 124. The galley 250 has cabinets 254 that are about 22 inches deep and have a length of about 54 inches and are disposed proximal the dinette unit 160. The cupboards and cabinets 252, 254 have a height of about 30 inches, and a counter 258 is supported thereon and may be about ¾ inches thick. The cupboards and cabinets 252, 254 may be made from bamboo or other suitable green materials. The cupboards and cabinets 252, 254 have handles 255. A drawer 259 is disposed vertically above the cupboard 252 has a drawer handle 255a. As shown in FIGS. 29 and 30, the counter 258 is movable from a retracted position 260 to a working position 262 by applying a lifting force in the direction of the arrow designated M in FIG. 29 and an opposite lowering force in the direction of the arrow designated N in FIG. 30 on the counter 258. In the working position 262 the height of the counter 258 may be about 33-35 inches as measured from the floor 101 of the camper box 24.

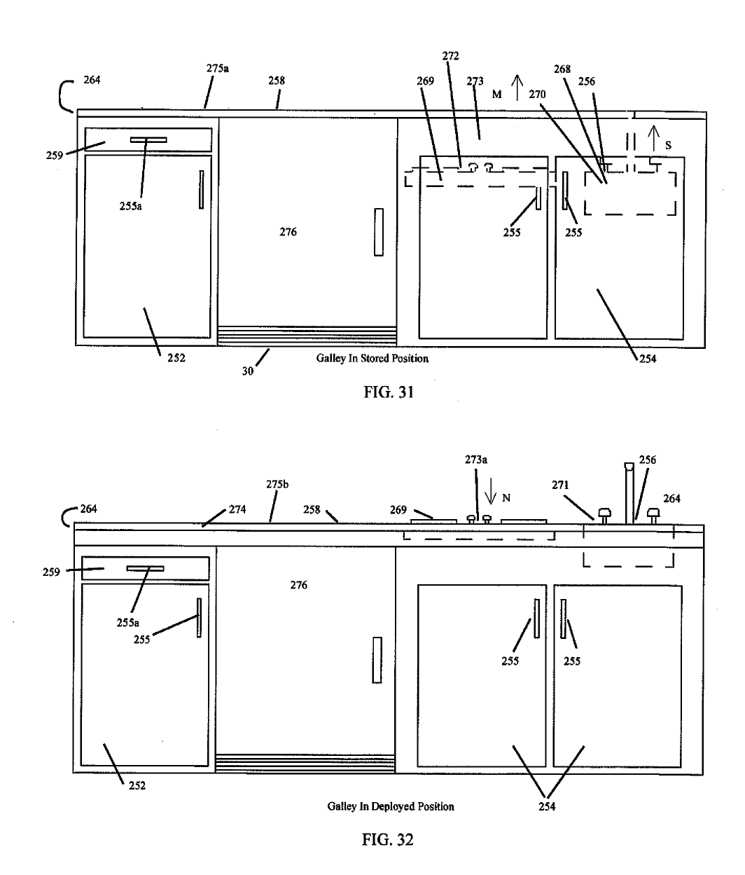

A V-hinged leg brace 264 is provided and a first hinge end 264a end is joined to the counter 258 and a second hinge end 264b is joined to the cupboards 252 and cabinet 254. The V-hinged leg brace 264 allows for the counter 258 to be moved between a lowered counter position 275a and a raised counter position 275b as indicated by the arrows designated M and N. The V-hinged leg brace 264 may be locked in place by a locking pin 265 when the counter 258 is in a raised counter position 275a. As shown in FIG. 31 a sink 256 is disposed in a recess 268 about 6-8 inches deep formed in the galley cupboard 254 and may be raised and lowered in the direction of arrows M and N from a sink stored position 270 to a sink working position 271 by applying lifting and lowering forces on the sink 256. A stove 269 is disposed in a stove recess 272 and may also be raised and lowered in the directions of arrows M and N from a stove stored position 273 to a stove raised position 273a. The previously mentioned propane tank 119 provides gas for the stove 269. After all the above components are deployed, there are about 7 (seven) feet in length of galley storage space 274 disposed under the counter 258 and sink 256, and it is pointed out that a refrigerator 276 is disposed beneath the counter 258. The galley storage space 274 is shown in FIGS. 31 and 32. The galley 250 is advantageously supported on the frame 30 such that additional support bracing is not required. The 7 (seven) feet of galley space 274 is advantageously about twice the area of existing galleys and provides the camper with considerable utility.

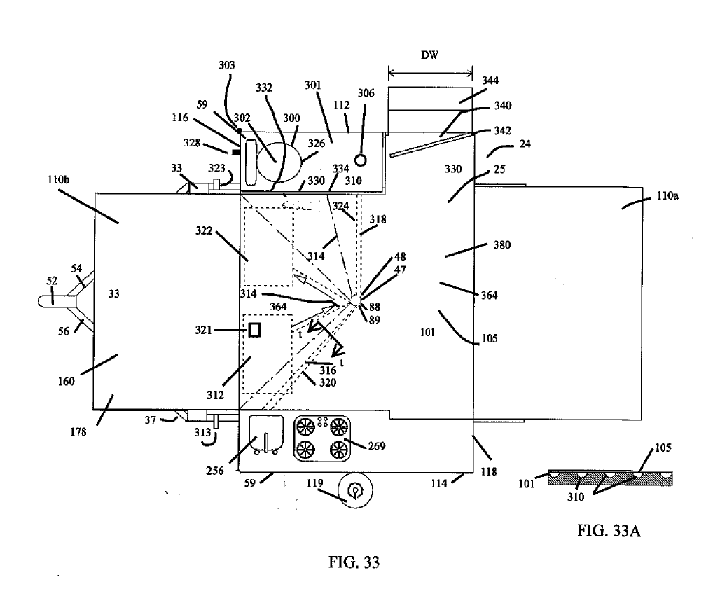

FIG. 33 is a top plan view of a shower and toilet unit 300 disposed in the camper box 24, and FIG. 33A is a sectional view a portion of the floor 101 of the camper box 24 taken along line T-T of FIG. 33. It is pointed out that the roof 110 is not present. The shower and toilet unit 300 has a shower and toilet floor 301. The shower and toilet unit 300 is positioned along the door side wall 112 of the camper box 24. A toilet 302 is positioned therein and extends about 18 inches beyond the frame 30. A shower 306 is also positioned in the shower and toilet unit 300. Variable length camper box braces 303 (shown extending into the page in FIG. 33) are attached to the camper box 24 at one end such that the person camping may move the variable length camper box braces 303 into contact with the ground 12 to provide support and stabilize the camper box 24.

A clean water tank 312 is supported under the floor 101 by the frame 30. The clean water tank 312 has a fill port 313 and a water pump 321 for providing pressurized clean water for the camper. A clean water hose 314 delivers clean water to the sink 256, toilet 302 and shower 306. The clean water hose 314 extends beneath the floor 101 and through the opening 48 in the pivot shaft housing 47, and in particular through the pivot shaft opening 89 defined in the pivot shaft 88. After the clean water hose 314 extends through the pivot shaft housing 47 it branches into a sink branch 316 and a toilet shower unit branch 318. The clean water hose 314 is sufficiently long such that it has play, that is, is about three inches worth of play so that it will not be stretched or otherwise damaged during rotation of the camper box 24. The grey water from the sink 256 is returned through a sink grey water return line 320 that extends to a grey water tank 322. The grey water from the shower 306 is returned through a shower grey water return line 324 to the grey water tank 322. The grey water tank 322 has a grey water tank drain 323. Black water generated in the toilet 302 is deposited in a black water tank 326 having a black water drain 328. Both the black water tank 326 and drain 328 are internal to the toilet unit 300 and thus move with the toilet as the camper box is rotated. The grey water tank 322 and a fresh water tank 312 are mounted on the frame 30 and each may have a capacity of about 25 gallons.

In addition, the toilet 302 and the shower 306 are positioned internal to a water containment shell 330 about 30 inches in height that keeps water internal to the shower and toilet unit 300. A shower curtain 332 is provided above the water containment shell 330 to retain water internal to the shower and toilet unit 300. The shower curtain 332 raises and lowers when the lifter posts 146 are raised and lowered. A bathroom door 334 is provided and opens into the interior 25 of the camper box 24. The bathroom door 334 has sufficient width to accommodate campers in wheelchairs.

As shown in FIG. 33A, the floor 101 has passages 310 for accommodating the above-described clean water hose 314, the sink grey water return line 320, the shower grey water return line 324, wiring 364, and other items that may need to extend beneath the floor 101. The floor 101 includes a cover 105 that encloses the described clean water hose 314, the sink grey water return line 320, the shower grey water return line 324, and wiring 364.

An outside door 340 is provided and connected with hinges 342 to the door side wall 112 proximal the shower and toilet unit 300. The outside door 340 has a width designated DW in FIG. 30 of about 30 inches in one of the preferred embodiments. The outside door width DW is advantageously wide enough to accommodate disabled campers, for example people in wheelchairs. Fold-down stairs 344 are provided and are sufficiently sturdy to serve as a brace for door side wall 112 of the camper box 24, which may extend out about 18 inches from the frame 30.

As described above, the frame 30 of the trailer 22 is advantageously different as compared to traditional trailers in use due to the cross support frame 42 and the higher center of gravity of the camper box 24. This advantageously provides for sufficient room for the clean and grey water tanks 312, 322. It may also provide space for a storage compartment 346 mounted on the frame 30, as shown in FIG. 12 for storing luggage and equipment. There may be several storage compartments 346 joined to the frame 30. In addition, it is pointed out that the lifter posts 146 mounted on the camper box base 100 are not welded to the frame 30 in one of the preferred embodiments, and this is different than other campers. For example, some Coleman® campers having lifter posts require the lifter posts to be in firm contact with the underlying frame such that there is no room for storage compartments. As referenced in FIG. 2 (but not shown deployed) an accessory awning 350 may be provided in one of the preferred embodiments which the camper pulls down from the galley side wall 114 of the camper box 24 when in the transport position 26 to protect equipment stored on the cargo deck 60 and for deflecting wind.

As shown in FIG. 33 the pivot shaft housing 47 houses the pivot shaft 88 having the pivot shaft opening 89 that align with one another when the pivot shaft 88 is positioned in the pivot shaft housing 47. Wiring 364 may be passed through the pivot shaft opening 89 along with the above-described hoses. Other wiring for phone, cable, fiber optics may extend through the pivot shaft opening 89. This arrangement prevents the electrical wiring 364 and the above-described tubes from becoming tangled during rotation of the camper body 24. The electrical wiring 364 provides a power source for electrical needs inside the camper body 24. As shown in FIG. 33A, the floor 101 of the camper box 24 defines passages 103 and the electrical wiring 364 extends through the passages 103 to any fixtures and outlets in the camper box 24. The floor 101 is comprised of bamboo in one the preferred embodiments. The above-described cover 105 covers the passages 310 for safety and ease of cleaning. A battery (not shown) or an external power source such as a generator (not shown) may be used as a power source.

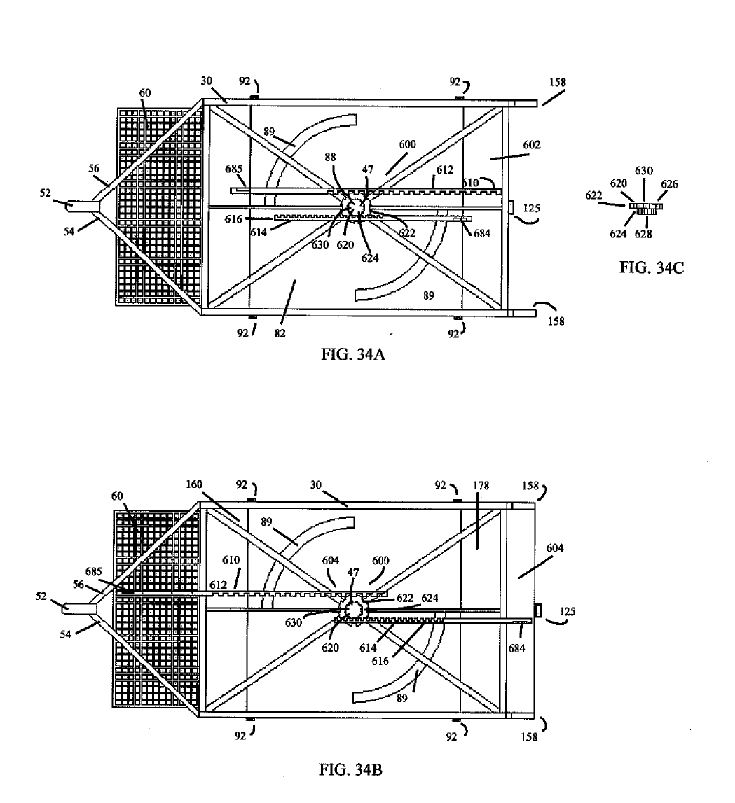

As previously mentioned, handles 125 are mounted to the bed and dinette side walls 116, 118 to allow the bed frame and box assembly 121 and dinette unit 160 to be manually pulled out of and pushed into the camper box 24. As an alternative, FIG. 34A is a bottom plan view of a rack and gear assembly 600 for extending the bed and dinette side walls 116, 118. The rack and gear assembly 600 is in a retracted rack position 602. FIG. 34B shows the rack and gear assembly 600 in an extended position 604.

The rack and gear assembly 600 has a first rack 610 having first rack teeth 612 and a second rack 614 having second rack teeth 616. The first rack teeth 612 are spaced farther apart from one another as compared to spacing between the second rack teeth 616.

As shown in FIG. 34C, the rack and gear assembly 600 also includes a central gear 620 having a first gear 622 and a second gear 624 that are joined to one another. The diameter of the first gear 622 is greater than that of the second gear 624. The first gear 622 has first gear teeth 626 sized to mesh with the first rack teeth 612 of the first rack 610. The second gear 624 has second gear teeth 628 sized to mesh with the second rack teeth 616 of the second rack 614. The gear ratio of the first and second gears 622, 624 is 2 to 1 in one of the preferred embodiments. The central gear 620 also has a central gear opening 630 such that it is capable of receiving the pivot shaft housing 47 therein.

It is pointed out that the gear and rack assembly 600 does not rotate as the camper box 24 is rotated to and from the transport and rotated positions 26, 28, because it is supported on the frame 30. The first rack 610 engages the dinette unit 160 when the camper box 24 is in the rotated position 28, and the second rack 614 engages the bed frame and box assembly 121 when the camper box 24 is in the rotated position 28. By pulling on the handle 125 the camper is able to simultaneously deploy both the dinette unit 160 and the bed frame and box assembly 121.

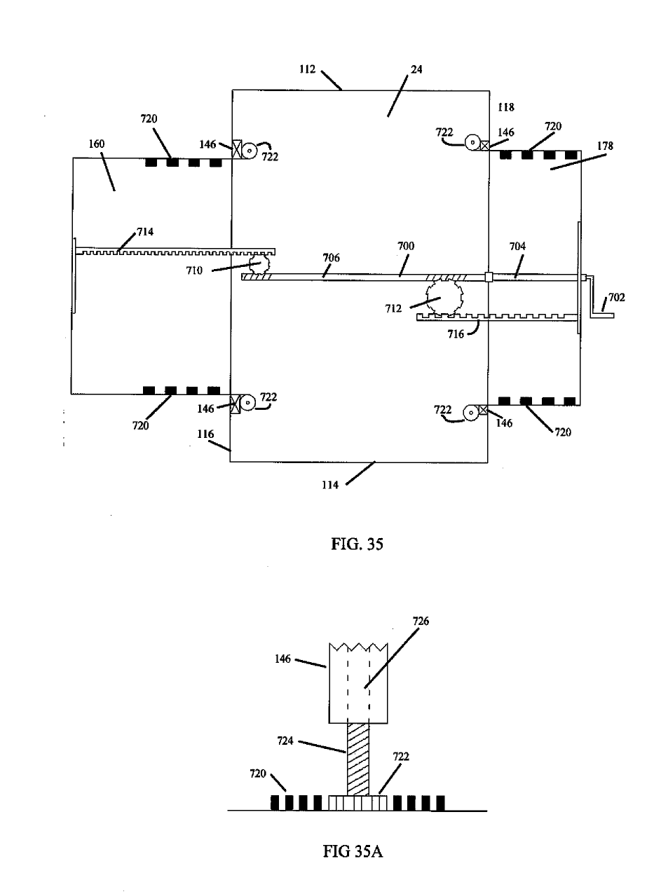

FIG. 35 is a bottom plan view of a hand crank deployment assembly 700 that provides an additional way for deploying the dinette unit 160 and the bed frame and box assembly 121 from the camper box 24 and simultaneously raising the lifter posts 146, so the task of raising the lifter 146 posts does not need to be done manually. The frame 30 is not shown for the sake of clarity. The hand crank deployment assembly 700 has a hand crank 702 that is connected to a crank bar 704. The crank bar 704 is connected to a worm gear 706. The crank bar 704 can be attached and detached from the worm gear 706 for storage purposes. The worm gear 706 engages a dinette gear 710 and a sleeper gear 712. The dinette gear 710 engages a dinette rack 714 and the sleeper gear 712 engages a sleeper rack 716. Rotating the hand crank 702 results in the dinette unit 160 and the bed frame and box assembly 121 being extended or retracted from the camper box 24.

In addition, as the hand crank 702 is turned the lifter posts 146 are automatically deployed to lift or lower the roof 110 of the camper box 24. In particular, there are four lifter racks 720 and four lifter gears 722. While turning the hand crank 702 to deploy the dinette unit 160 and the bed frame and box assembly 121 the lifter racks 720 automatically turn the lifter gears 722. As shown in FIG. 35A, each of the lifter gears 722 is connected to a riser screw 724 that is threaded into an internal lifter post thread 726 disposed in the lifter post 146. This causes the rotational motion of the lifter gear 722 to be converted to the linear motion of the lifter post 146. Thus, there is no need to manually lift the roof 100 of the camper box 24 in this embodiment.

FIG. 36 shows another embodiment of a way to raise the lifter posts 146. Belts, commonly designated 717, are provided and positioned around pulleys, commonly designated 725. As the hand crank 702 is rotated the belts 717 apply force to forcing arms 715 that in turn apply force on flexible forcing members commonly designated 730. The flexible forcing members 730, in turn, apply force on the lifter posts 146 thus extending them. FIG. 36A is an illustrative drawing showing the lifter posts 146 in an extended position 147.

Thus, the usable space of the floor 101 of the camper box 24 floor after it has been expanded in the manner described above is about 52 square feet in one of the preferred embodiments. One of the advantages of the camper box 24 is that the available interior camper space is exploited such that it takes on a generally square-shaped central living area 380 (see for example FIG. 33) that allows the camper easy access to all the facilities in the camper box 24. In one of the preferred embodiments the central living area 380 is about seven feet by seven feet. In addition, the design is superior to the narrow pathways found in other pop-up campers. And, the central living area 380 can accommodate a group of people sitting together which is difficult to do in other pop-up type campers. Another advantage is that after the camper box 24 has been expanded in the above describe manner the central living area 380 ideal for those in wheelchairs due to the larger doorways and the square-shaped central living area 380. The central living area 380 allows campers to use futons and other fold-out furniture (not shown) such that six or more people can sleep or socialize at any one time in the camper box 24.

The exterior surfaces 29 (FIGS. 2 and 4) of the camper box 24 are, in one of the preferred embodiments, clad in sage-green vinyl or vinyl-like materials and consumers may select various outdoor scenes or brown or green camouflage for additional harmonization with their camping environment. Consumers may select exterior surfaces 29 that have coloring reflecting deserts, mountains, or forests. The coloration may be achieved by the use of paints or thin design-printed films such as those employed on billboards. Printed films and the methods of making printed films are well known to those having ordinary skill in the art and are therefore not described in detail herein. The tenting 111 may also be embodied to reflect the above described coloring and aesthetics. The tenting 111 may comprise canvas and mesh and may be made from a plurality of different materials including natural materials such as hemp or canvas and man-made materials.

It will be appreciated by those skilled in the art that while the pop-up camper expansible through rotation 20 has been described in connection with particular embodiments and examples, the pop-up camper expansible through rotation 20 is not necessarily so limited and that other examples, uses, modifications, and departures from the embodiments, examples, and uses may be made without departing from the pop-up camper expansible through rotation 20. All these embodiments are intended to be within the scope and spirit of the appended claims.

What is claimed is:

1. A pop-up camper expansible through rotation comprising:
a camper box having a pivot shaft;
a trailer having a frame;
a cross support frame joined to the frame and having a substantially centrally positioned pivot shaft housing; and,
wherein the pivot shaft is positioned in the pivot shaft housing such that the camper box is rotatable relative to the frame from a transport position to a rotated position.

2. The pop-up camper expansible through rotation according to claim 1 further including a rectangular shaped frame rotation plate having a frame rotation plate opening and the rectangular shaped frame rotation plate is supported on the frame such that the pivot shaft passes through the frame rotation plate opening.

3. The pop-up camper expansible through rotation according to claim 2 wherein the frame rotation plate is made of a low friction material.

4. The pop-up camper expansible through rotation according to claim 1 further including a camper box rotation plate with first and second plate sides wherein the first plate side is joined to a base of the camper box and the pivot shaft extends from the second plate side.

5. The pop-up camper expansible through rotation according to claim 4 wherein the camper box rotation plate is made of a low friction material.

6. The pop-up camper expansible through rotation according to claim 2 wherein the frame rotation plate has an curved slot and at least one frame box stop extends from the frame rotation plate and wherein a camper box stop extends from the camper box rotation plate and into the slot such that the camper box range of motion is limited to about ninety degrees of rotation.

7. The pop-up camper expansible through rotation according to claim 1 further including a rotation track supported on the cross support frame and wherein the camper box has camper box stops that are received in the track such that the camper box is rotatable relative to the frame on the track to and from the transport position and rotated position.

8. The pop-up camper expansible through rotation according to claim 1 wherein the pivot shaft housing has a pivot shaft housing opening and the pivot shaft has a pivot shaft opening and the pivot shaft housing opening and the pivot shaft opening have a common central axis.

9. The pop-up camper expansible through rotation according to claim 1 wherein the camper box has a dinette side wall disposed opposite a bed side wall, and a galley side wall disposed opposite a door side wall.

10. The pop-up camper expansible through rotation according to claim 9 further having a dinette unit deployable from the dinette side wall when the camper box is in the rotated position and wherein the dinette unit is reconfigurable into a sleeper unit with an optional hammock-like meshed box spring capable of supporting a mattress.

11. The pop-up camper expansible through rotation according to claim 9 further having a bed frame and a bed box capable of being deployed from the bed side wall when the camper box is in the rotated position.

12. The pop-up camper expansible through rotation according to 9 wherein the camper box has a floor and a dinette unit deployed from the dinette side wall when the camper box is in the rotated position and having a bed frame and box assembly deployed from the bed side wall when the camper box is in the rotated position to form a central living area having a substantially square shape when the dinette unit and the bed frame and the bed box are deployed.

13. The pop-up camper expansible through rotation according to claim 1 further including a rack and gear assembly and a handle is mounted on the camper box such that pulling on the handle deploys the dinette unit and the bed frame and box assembly.

14. The pop-up camper expansible through rotation according to claim 1 further including a hand crank deployment assembly for deploying the dinette unit and the bed frame and box assembly and raising a roof of the camper box.

15. The pop-up camper expansible through rotation according to claim 1 wherein the trailer has a retractable tongue and the frame has a guide that is adapted to receive the retractable tongue such that the retractable tongue is movable from an extended position to a retracted position such that when the tongue is in the retracted position storage space requirements are decreased.

16. The pop-up camper expansible through rotation according to claim 1 wherein the trailer has a tongue and a hinge joins the trailer to the frame and wherein the tongue is movable between a stored position and a deployed position

17. The pop-up camper expansible through rotation according to claim 1 further including a galley having cupboards and cabinets and a counter, and a V-hinged leg brace joins the counter and the cupboards and cabinets such that the counter may be raised and lowered

18. The pop-up camper expansible through rotation according to claim 17 wherein the counter has a recess and a sink is disposed in the recess and the sink is movable between a sink stored position and a sink working position such that the sink is operational when in the sink working position.

19. A pop-up camper expansible through rotation comprising:
a trailer having a frame and a cross support frame with a pivot shaft housing;
a camper box having a pivot shaft positioned in the pivot shaft housing and further having a dinette side wall disposed opposite a bed side wall, and a galley side wall disposed opposite a door side wall and wherein the camper box is rotatable between transport and rotated positions; and,
wherein when in the rotated position a dinette unit is deployed from the dinette side wall and a bed frame and a bed box are deployed from the bed side;
a galley, a dinette unit, a toilet and shower unit and a bed and bed box assembly disposed in the camper box, and,
a central living area defined in the camper box when the when the dinette unit and the bed frame and bed box are deployed and the central living area having a generally square shape such that the central living area allows easy access to the galley, dinette unit, toilet and shower unit and the bed and bed box.

20. A method for providing a pop-up camper expansible through rotation comprising the acts of:
providing a camper box and providing the camper box with a pivot shaft;
providing a trailer having a frame with a first, a second, a third and a fourth corner;
providing a cross support frame having a pivot shaft housing and joining the cross support frame to the first, second, third and fourth corners such that the pivot shaft housing is substantially centrally positioned in the frame; and,
positioning the pivot shaft in the pivot shaft housing such that the camper box is rotatable relative to the frame.
